(19) United States
(12) Patent Application Publication
(10) Pub. No.: US 2010/0274830 A1
(43) Pub. Date: Oct. 28, 2010

(54) Budget tracking calculator system and method

(75) Inventor: Jonathan Stever, Stony Brook, NY (US)

Correspondence Address: Charles Muserlain, 317 Bliss Lane, Valley Cottage, NY, 10989, US

(73) Assignee: BUDGET TRACKING SOLUTIONS, LLC

(21) Appl. No.: 12/386,802

(22) Filed: Apr. 23, 2009

(51) Int. Cl. G06F 3/00; G06F 13/00

(52) U.S. Cl. 708/132; 708/174

(57) ABSTRACT

A budget tracking calculator system and method is disclosed, comprising a portable calculating device operating under software control and configured to permit a user to record budgetary expenditure data and other transaction data via a keypad. Four operating modes are provided—calculator, transaction entry, graphing and PC interface. In the transaction entry mode, the user may enter expenditure data into a variety of expenditure categories, to minimize manual data entry time and effort.

### NO GOVERNMENT RIGHTS

No federally-sponsored research or development was involved with this application.

### FIELD OF THE INVENTION

The present invention relates to electronic calculating devices and systems for tracking financial and budgetary transactions, and more particularly to a portable, multi-function device and associated software for recording and displaying transactions and expenses to permit a user to easily monitor and manage a financial budget.

### BACKGROUND OF THE INVENTION

Planning and tracking a financial budget is useful for many individuals, particularly in times of economic difficulty. Budget tracking would be even more useful if the individual could track his or her budget in real time using a portable budget tracking device that could record, track, display and graph budget expenditures by category, and also communicate with external computers for later display and analysis.

A number of portable electronic calculating devices are currently commercially available for solving or simplifying certain financial or business-oriented tasks, such as calculating mortgage data, balloon payments, depreciation, bond prices and yields, time value of money for savings, loans, leasing, amortization schedules, cash flows, percentages and the like. Other calculators attempt to combine business and finance functions with scientific tasks, such as math functions including trigonometric calculation, natural logarithms and powers. See, for example, U.S. Pat. Nos. 4,192,006; 4,910,696; 4,961,158; 6,305,603; and 6,609,095.

Existing calculators do not, however, allow for the simple recording of receipts, expenses or payments, by category and date, in such a way that the consumer can efficiently record, track, store, transfer, graphically display and evaluate those expenditures in a simple and practical way, for the purpose of immediate summation from the device as well as future electronic transfer to another computer running software designed to accept such information and convert it into an organized format.

Thus, a need exists for a system, including a portable device and associated software, that allows a user to record receipts, expenses and payments in such a way as to efficiently track, store, transfer, graphically display and evaluate expenditures in a simple and practical way, for budget planning and related purposes, with a minimal need for the user to engage in time-consuming manual data entry.

### SUMMARY OF THE INVENTION

The present invention fulfills the needs in the prior art for an easy-to-use, hand-held device and associated software for expense recording and budget planning, tracking, analysis, management, and graphical display. Expenditures can be recorded by category and sub-category. A number of common category “paths,” such as “automobile expenses,” “office expenses” and the like, are pre-programmed into the device to help save time for the user. The invention may also be customized to add different or additional categories, if desired.

More specifically, the present invention comprises a portable calculating device operating under software control and configured to operate in any of four modes: (a) a calculator mode for permitting a user to perform numerical calculations; (b) a transaction entry mode for permitting the user to record monetary expenditure data into a memory in the device via keys; (c) a graphing mode for permitting the graphical display of expenditure data directly on a display screen; and (d) an interface mode for permitting the device to communicate with an external personal computer; the device being configured to record and display data in a plurality of different pre-programmed categories and sub-categories of types of expenditures.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a perspective external view of a portable calculator device in accordance with this invention;

FIG. 2 is a perspective external view of an alternative embodiment of the device of FIG. 1;

FIG. 3 is a tree/flow diagram illustrating the logical arrangement of some typical business and personal financial expenditure categories and sub-categories that are available for display to and selection by a user of the invention, with an entry point designated “BTC”, which stands for Budget Tracking Calculator;

FIG. 4 is an overall state-transition/flow diagram showing typical states that the device of the invention transitions through as a user chooses different operating modes;

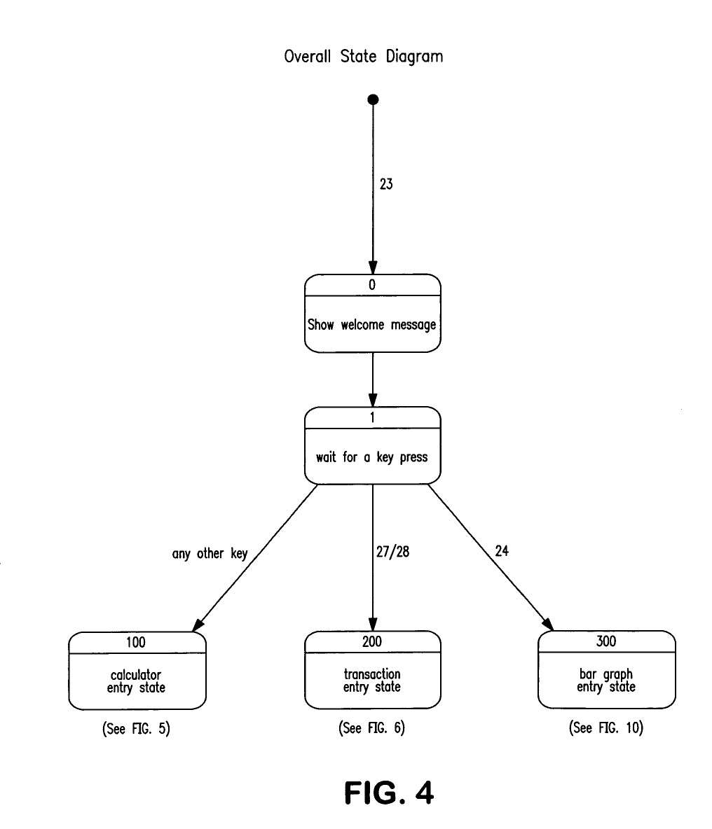

FIG. 5 is a state-transition/flow diagram of typical steps that a user proceeds through while in a basic calculator mode of the invention;

FIG. 6 is a state-transition/flow diagram of typical steps that a user proceeds through while in a transaction entry mode of the invention;

FIG. 7 is a more detailed flowchart illustrating the transaction entry steps of FIG. 6;

FIG. 8 is a side-by-side view of an abbreviated flow diagram of one sample sequence of a selected transaction expense category/subcategory path (e.g., auto expenses) next to a pictorial diagram of a series of visual icons that appear on a display screen as a user proceeds through the category/subcategory path;

FIG. 9 shows a more detailed flow diagram of the sequence of FIG. 8;

FIG. 10 is a state-transition/flow diagram of typical steps that a user proceeds through while in a bar graph mode of the invention;

### DETAILED DESCRIPTION OF THE INVENTION

### Overview

The present invention is a portable computing device and system designed for the quick and easy recording and graphic evaluation of receipts, expense outlays and payments into selected categories chosen by the user through a simple key entry process, and has the capability to transfer this expense data by electronic cable or wireless transfer to another computer running proprietary software at a time convenient to the user.

The invention is designed to record and store expense data, either entered manually with keystrokes from the user, or automatically, such as from a scanner or other device. Later, the data can be transferred automatically to a remote computer running software that includes spreadsheet, graphing, and budget targeting and tracking features. The software also allows for the manipulation, creation, arrangement and transfer of various categories to the budget calculator as per the user's specific and unique spending needs.

Preferably, the system of the invention is a system comprising: (1) a portable, hand-held calculator device, approximately the size of a conventional personal numeric calculator, and operating under internally-stored, proprietary software; and (2) stand-alone proprietary software, configured to be stored in and operate functions of an external computer, and to communicate with, receive data from, and analyze and display data from the calculating device.

### Calculator Device

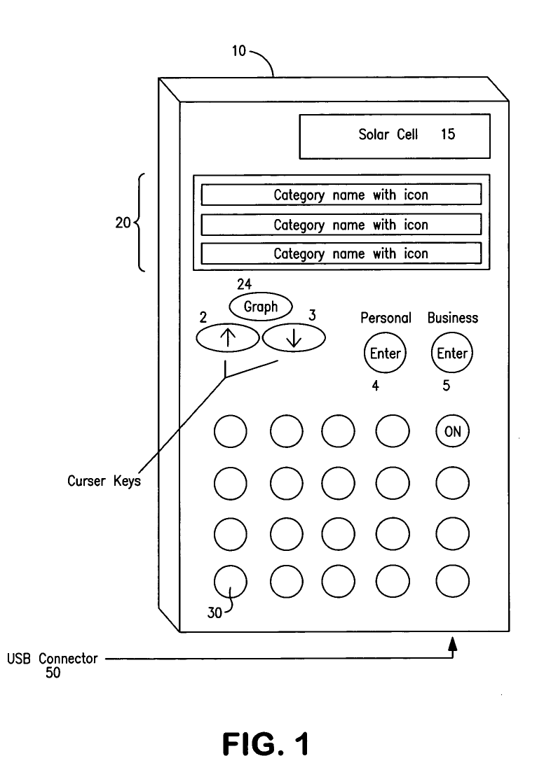

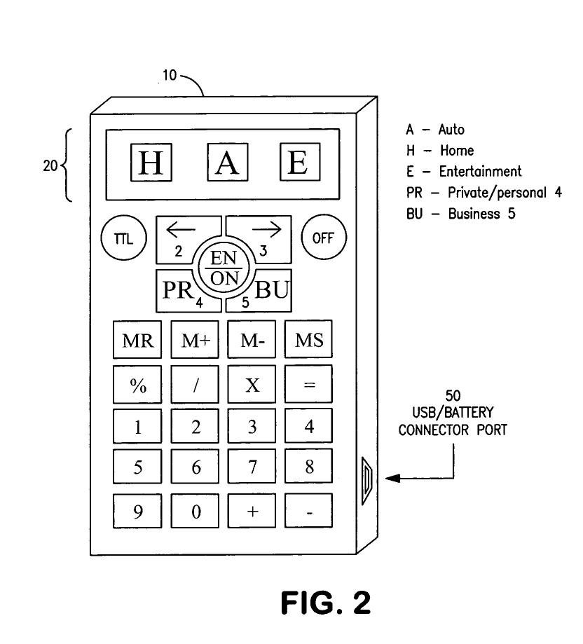

Turning now to the drawings, FIG. 1 shows a portable calculator device 10 in accordance with the invention. FIG. 2 shows an alternative embodiment of the device. The device is preferably of a small size and weight that makes it practical for easy transport and access, whether in the pocket of one's clothing or in a protective wallet, pouch or handbag. The device may also consist of a non-portable desk or table-top device.

The calculator device is powered by conventional electronic processor, memory, communications and associated integrated circuit components (not shown). The device has a multi-function LCD or other display screen 20 that allows for ready viewing and depiction of expense categories (described below), numeric calculations, and graphing functions (described below) unique to the device.

The device also has a conventional numeric keypad with a plurality of manually-operated keys 30 (FIG. 1) mounted on the front surface that allows for basic mathematical and/or financial functions. In addition, in a feature of the invention, the device also has additional, specialized multi-function keys, such as keys or buttons 4, 5, 24, that allow the user to select various operational modes and functions, such as whether data to be entered relates to a personal matter (key 4) or a business matter (key 5). In an alternative embodiment, specialized financial function keys (not shown) are also provided, such as special TTL (total) keys and other keys to allow the user to quickly calculate automobile mileage, and perform other calculations.

A universal serial bus (USB) or other connector port 50 is also provided for connection to an external computer for data transfer, or for battery recharge. The calculator may be powered by a battery, a solar cell 15, or an external power supply. A touch screen may be employed instead of a manual keypad, if desired. In an alternative embodiment, the calculator can also operate with voice commands.

The display screen 20 is configured to display, among other things, a variety of icons during operation. Each icon represents an expense category, such as a home or household expense (symbol “H” in FIG. 2); an automobile expense (symbol “A” in FIG. 2); or an entertainment expense (symbol “E” in FIG. 2).

Operational Modes In a preferred embodiment of the invention, the calculating device is configured to run in any of four different operational modes—calculator mode, transaction entry mode, graphing mode, and PC interface mode. These are described in more detail below.

### Calculator Mode

One operational mode of the device is a calculator mode, in which the calculator is configured to perform functions similar to those of a conventional calculator—for example, addition, subtraction, multiplication, division, percentages, square root and the ability to handle negative numbers, along with memory functions and entry clearing ability. Financial calculations may also be performed. Preferably, when the calculator is initially powered on, it automatically starts in calculator mode as a default.

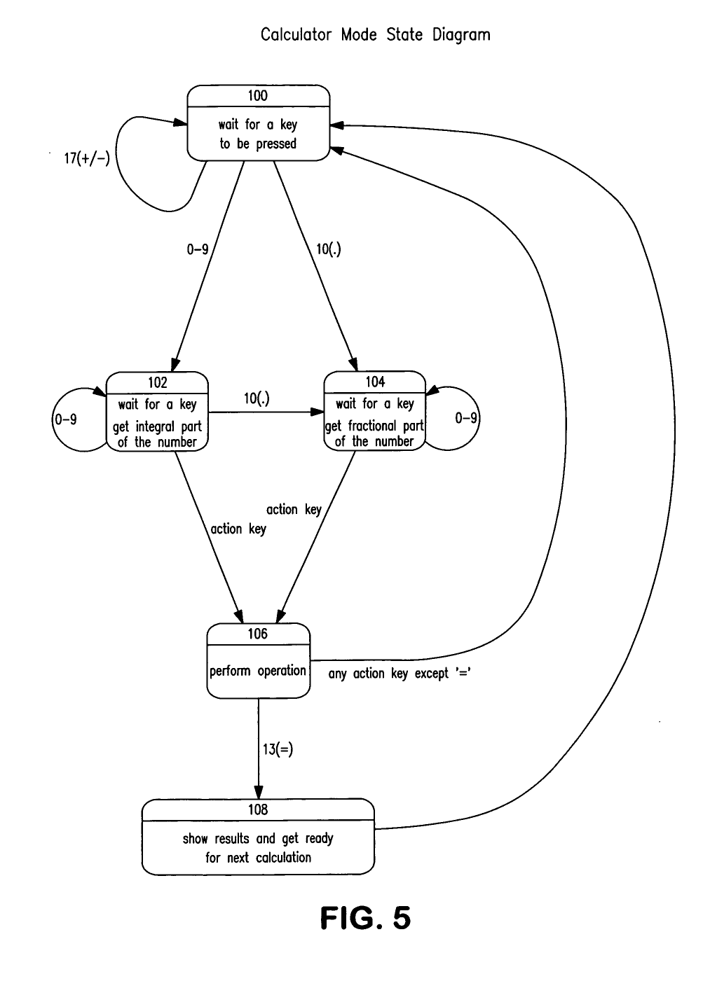

FIG. 5 shows a state-transition/flow diagram of typical steps that a user proceeds through to perform calculations while in a basic calculator mode of the invention.

### Transaction Entry Mode

In another important feature of the invention, a second operational mode consists of a transaction entry mode, in which transaction and expense data may be entered by the user on the keypad, using various pre-programmed expense categories to save data entry time and effort.

### Categories

As used herein, the term “category” means a type or class of monetary expenditure or expense. Numerous different categories of expenses exist. In a feature of the invention, to save time for the user, a number of commonly-used categories and sub-categories are initially programmed into the calculator device and system, so that the user does not need to keep re-entering them when keying in expense data.

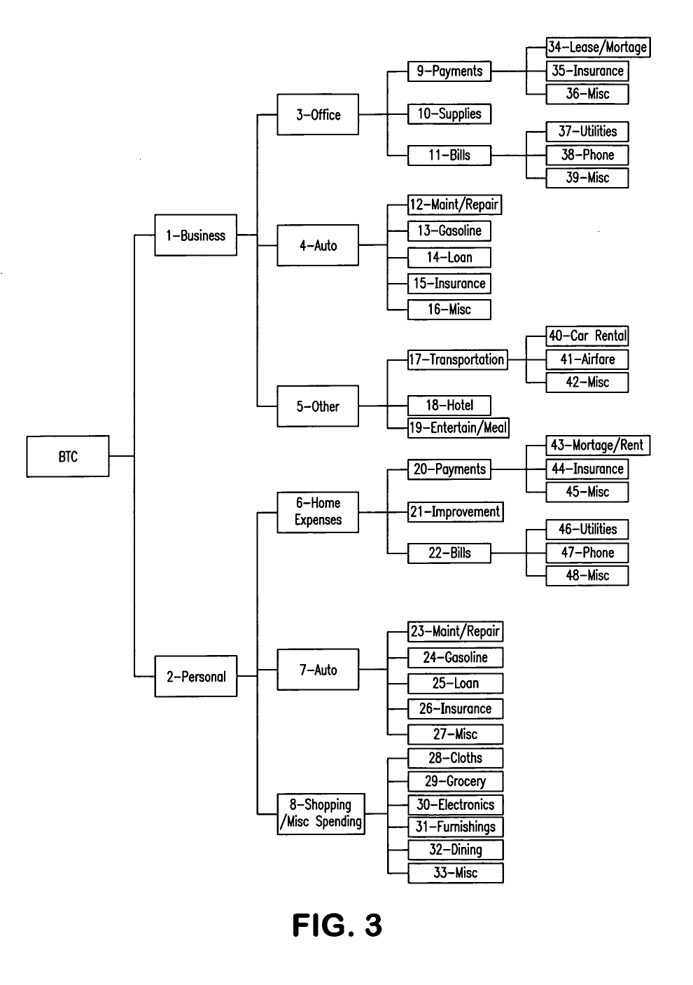

FIG. 3 is a tree/flow diagram illustrating the logical arrangement of some typical business and personal financial expenditure categories and sub-categories and category paths that are available for display to and selection by a user of the invention.

The entry point is designated “BTC”, which stands for Budget Tracking Calculator.

Next, in FIG. 3, the diagram branches into two primary categories, namely “business” and “personal.” If the user wishes to change or add to these primary categories, the user will be presented with screens to accept these choices.

Within each primary category group, and continuing through the sub-category and sub-sub-category and deeper levels, the user may access a range of other pre-programmed, commonly used, expense categories.

A “sub-category” means a more specific type of expense logically grouped “under” or within a primary category, and along a logical category path, and pre-programmed into the calculator. For example, as can be seen in FIG. 3, under the sub-category “BTC—2—personal—6—home expenses,” a number of further sub-sub-categories are available to be accessed and selected by the user, such as “20—payments”, “21—improvement” and “22—bills”.

Some of the sub-subcategories are further broken down into sub-sub-sub categories, and even deeper levels. For example, in the embodiment of FIG. 3, the sub-sub-category “20—payments” is further broken down into the sub-sub-sub-categories “43—mortgage/rent”, “44—insurance” and “45—miscellaneous.”

The pre-programming of common expenditure categories into the calculator device of the invention saves a great deal of data entry time and effort for the user.

For example, the user need not manually key in the name of each category each time an expense is keyed in. The user need only select a category or sub-category presented to the user on the display, and key in only minimal information associated with a particular transaction, such as a dollar amount and, optionally, a date. The calculator memory stores the dollar amount associated with each transaction entered within each category, and also the date and other related information. The date may be entered manually or automatically set by a built-in clock within the device.

A huge number of transactions may be stored in the calculator's memory. Additional, removable memory devices, such as flash memory devices, may also be employed to store more transactions.

### Customization

The user may also customize the calculator to create new categories, delete categories, or change the pre-programmed information associated with each category. For example, looking again at FIG. 3, if the user wanted to record the name of a particular bank to which mortgage payments were made, the user need only customize the path labeled “BTC—2—personal—6—home expenses—20—payments—43—mortgage/rent” in advance to automatically associate the name of that particular bank with mortgage payments made. Thereafter, the calculator device of the invention will automatically associate a recorded mortgage payment with that particular bank.

### Operation

### Calculator/Financial Mode

In the calculator/financial mode, the user may perform arithmetic, financial and related operations, using conventional calculator keys 30 as shown in FIG. 1. A typical sequence of keystroke operations in the calculator mode is shown in FIG. 5.

### Transaction Entry Mode

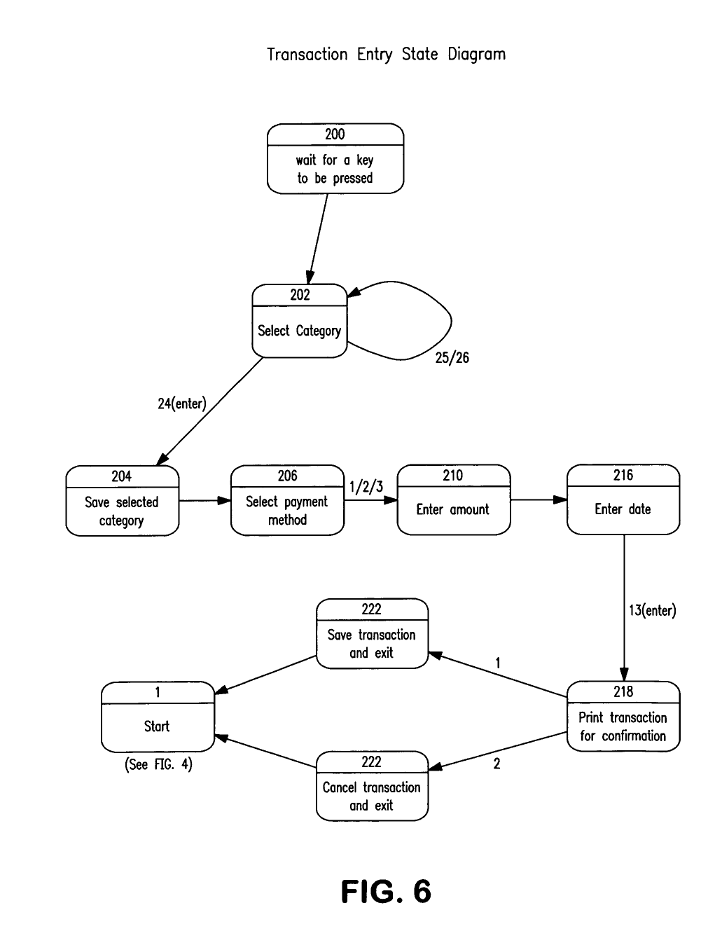

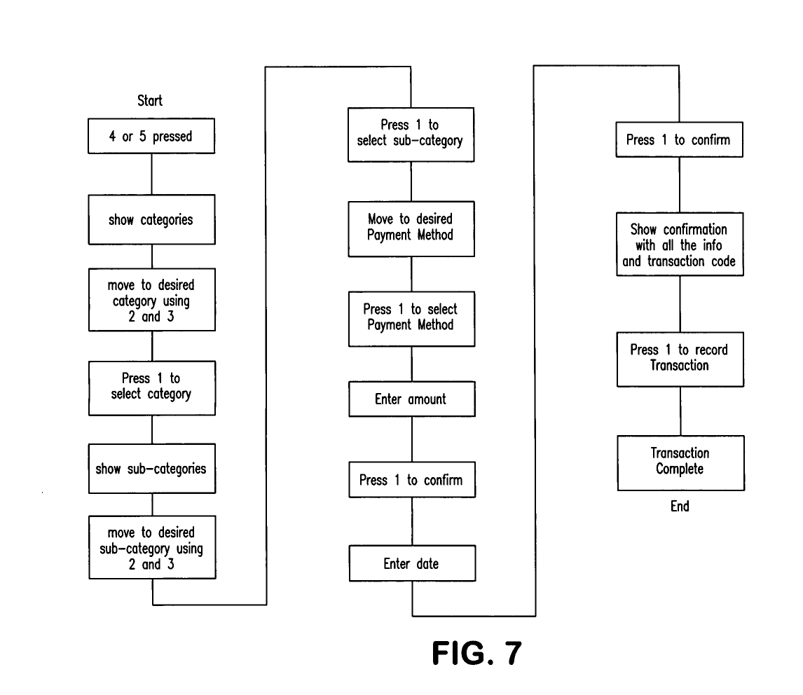

A typical operational sequence of the transaction entry mode of the invention will now be described, with reference to FIGS. 6-9. In a feature of the invention, prior to first use, the user is prompted to enter a “target” monetary amount that the user wishes to record for one or more primary categories and/or sub-categories that the user may wish to keep in mind for future budget planning. This feature is quite useful for budget planning and for helping the user to maintain discipline over various expenditures.

For example, the user may decide that his or her current budget will only allow for a particular amount of money per month for gasoline for a personal car. The user may enter this amount into the calculator's memory.

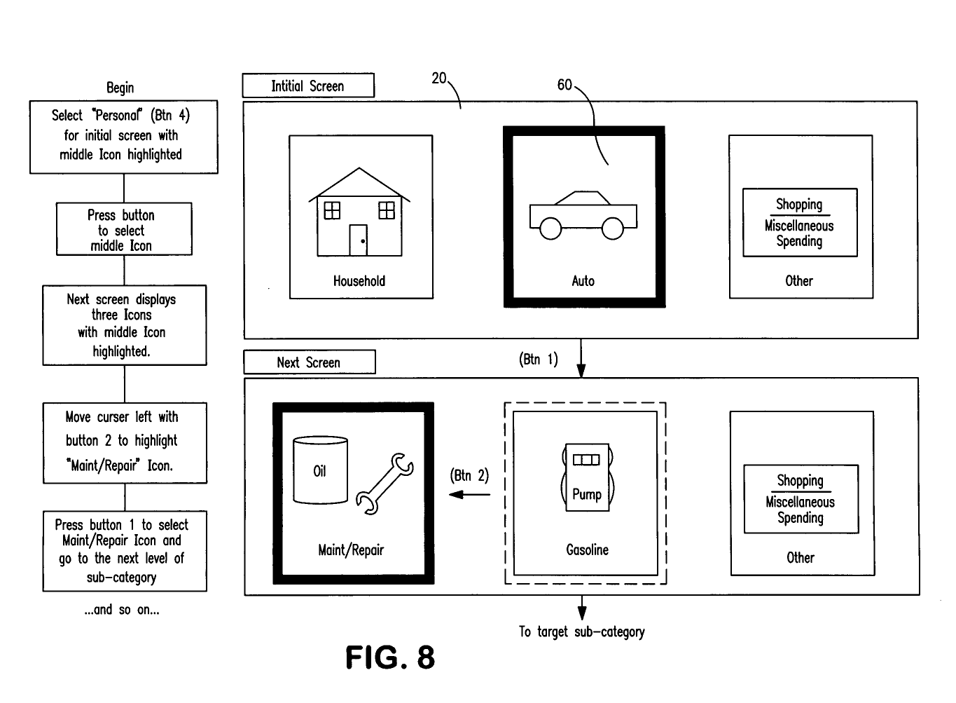

Next, in one example, as in FIG. 8, the user has purchased gasoline for his or her car. Using a hand-held version of the calculator, the user presses a key on the calculator dedicated to the primary category “Auto” expenses, or selects the icon for “Auto” using a keystroke or mouse, etc.

Next, the software running on the calculator displays a number of sub-categories, such as “Maint/Repair”, “Gasoline”, and “Other”. Next, further sub-categories (not shown) may be displayed, if necessary, such as “change oil filter” or the like, if the user needs information in more detail. The user continues in this fashion until the proper sub-category is reached.

Once the user locates and selects the proper sub-category, a numeric field is displayed on the calculator's display, and the user is prompted to enter the amount of the expenditure by use of the numeric keypad.

After the amount has been entered, a date field is displayed, and the user enters the date of the transaction in the same way, if desired. In an alternative embodiment, the calculator software runs an internal electronic clock that automatically enters the current date and time that will be associated with the data input by the user for that transaction.

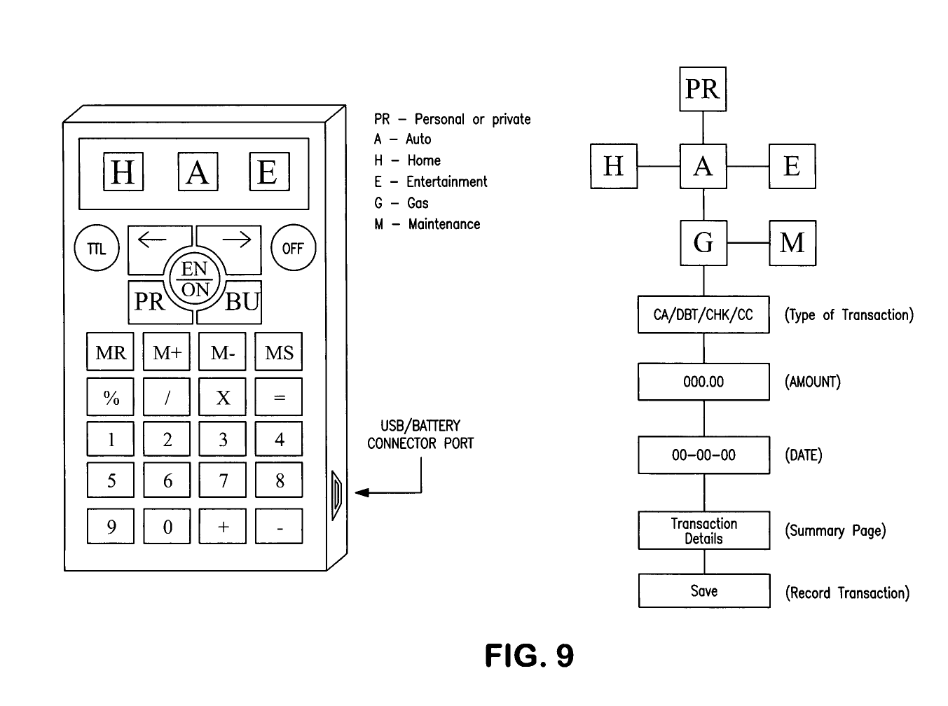

Next, the user is prompted to select a form of payment. FIG. 9 shows several choices, such as CA (cash), DBT (debit card), CHK (check), and CC (credit card).

After the form of payment has been entered, a summary of the transaction appears on the display, and the user is prompted to confirm whether the recorded entries are accurate. If the entries are not accurate, the user may back- track using a dedicated key on the calculator to make necessary corrections and review the summary again. If the entries are accurate, they may be printed and/ or saved.

FIG. 8 is a side-by-side view of an abbreviated flow diagram of one sample sequence of a selected transaction expense category/subcategory path (e.g., auto expenses) next to a pictorial diagram of a series of visual icons that appear on a display screen as a user proceeds through the category/subcategory path;

In FIG. 8, the icon for automobile expenses is highlighted. If the user selects that icon by pressing the numeric “1” key (while in transaction mode), or otherwise selects the icon using a mouse or other pointing device; then a second screen appears with several sub-categories displayed that are related to and logically included within the primary category of auto expenses.

Once an accurate transaction summary is displayed, a code or other notation is displayed indicating that the transaction is complete and recorded into memory, associated with the receipt or invoice being recorded.

### Graphing Mode

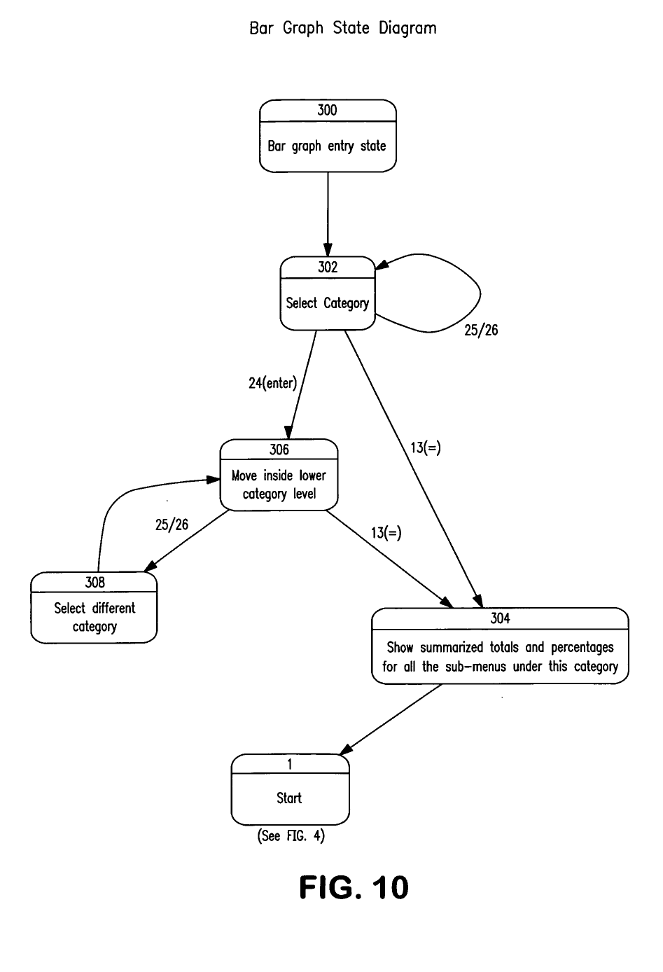

In another feature of the invention, a third mode of operation of the calculator is a data graphing mode, illustrated in FIG. 10. After the user has recorded transaction data into the calculator memory, the data may be displayed on the calculator display by pressing a dedicated “graph” key 24 (see FIG. 1), or typing in the numbers 24 on the numeric keypad, while in calculator mode.

Once the graph mode is entered, a horizontal bar graph display (not shown) will appear on the display screen, showing the first “page” of sub-categories. If the graph key is pressed again, the next page of sub-categories will appear, and so on until all sub-categories have been accessed.

Each bar graph numerically and graphically displays both the current amount of spending that has occurred in a particular sub-category, and a corresponding “target” amount, if any, budgeted for that primary category and sub-category, as previously determined by the user.

The user may also scroll down through other bar graphs and highlight another particular sub-category, and then press the graph key once again to display information pertaining to the entries recorded in that sub-category.

### PC Interface Mode

In another feature of the invention, a fourth mode of operation of the calculator is a PC interface mode. In this mode, the calculator device is configured to “talk” to another external device, such as a conventional personal or business computer (“PC”).

To accomplish this, a separate software program is provided as part of the invention that is configured to run on a personal computer, and to communicate and operate together with the software program running on the calculator. These two programs allow the user to transfer or upload the expense data recorded on the calculator into an organized accounting format automatically on the PC, according to expense code designations assigned at the point of original record entry.

The software on the PC distributes expense data into a spreadsheet format, arranges the data chronologically and otherwise, according to the date of expenditure, with primary category and sub-category totals displayed for each primary category and sub-category in a “bottom line” total.

The software running on the PC also separates the expenditures into monthly primary categories and sub-categories to allow the user to review whether he or she is meeting or exceeding his or her targeted spending limits for that period. The PC software also allows the user to manipulate various features in order to personalize or customize the interaction between the calculator and the PC to his or her unique financial needs and budget targets and expectations.

While particular embodiments of the invention have been described, it will be apparent to those skilled in the art that various modifications thereof may be made without departing from the true spirit and scope of the invention. Accordingly, it is intended by the appended claims to cover all such modifications and equivalents which embody the inventive features as defined in the claims.

What is claimed is:

1. A budget tracking calculator system, comprising:
a calculator device operating under software control and configured to operate in any of four modes, comprising:
(a) a calculator mode for permitting a user to perform numerical calculations;
(b) a transaction entry mode for permitting the user to record monetary expenditure data into a memory in the calculator via keys;
(c) a graphing mode for permitting the graphical display of the data; and
(d) an interface mode for permitting the calculator to transfer the data to an external computer;
the calculator further being configured to record and display the data in a plurality of different pre-programmed categories and sub-categories of types of expenditures.

2. The system of claim 1, in which the categories and sub-categories may be customized by the user to meet the user's particular budgetary needs.

3. Computer software configured to operate on a personal computer and configured to communicate with, receive, analyze and display data representative of categorized monetary expenditure data recorded on a budget tracking calculator device.

4. A budget tracking method, comprising the steps of:
(a) entering data representative of one or more budget expenditure target amounts into a calculator, each target amount associated with an expenditure category;
(b) recording expenditure data in the calculator by expenditure category;
(c) graphically displaying summaries of the expenditure data on the calculator;
(d) transferring the expenditure data to a personal computer; and
(e) analyzing and displaying the expenditure data on a display screen.
